(19) United States
(12) Patent Application Publication
(10) Pub. No.: US 2016/0335627 A1
(43) Pub. Date: Nov. 17, 2016

(54) METHOD, DEVICE AND A SERVER FOR SIGNING DATA

(71) Applicant: GEMALTO SA, Meudon (FR)

(72) Inventors: Didier HUGOT, Austin, TX (US); Pierre BROUSSEAU, Boulogne Billancourt (FR)

(73) Assignee: GEMALTO SA, Meudon (FR)

(21) Appl. No.: 14/708,855

(22) Filed: May 11, 2015

(51) Int. Cl. G06Q 20/38; H04L 29/06; G06Q 20/40; H04L 9/32

(52) U.S. Cl. CPC G06Q 20/3825; H04L 9/3247; H04L 63/061; H04L 63/0876; G06Q 20/401

(57) ABSTRACT

The invention relates to a method 20 for signing data.

According to the invention, the method comprises the following steps. A device generates a first cryptogram by using a predetermined payment transaction key, a predetermined algorithm and data relating to data to be signed, as input to the algorithm. The data to be signed being different from payment transaction data. The device sends, without going through any payment transaction channel, to a first server a first message including a request for validating a signature relating to the data to be signed accompanied with the first cryptogram and the data relating to the data to be signed. The first or a second server generates a second cryptogram by using the predetermined payment transaction key, the predetermined algorithm and the data relating to the data to be signed, as input to the algorithm. The first or the second server compares the second cryptogram to the first cryptogram. If the second cryptogram does or does not match the first cryptogram, then the first or the second server does or does not validate a signature relating to the data to be signed respectively.

The invention also relates to corresponding device 12 and server(s) 18 (and 110).

### FIELD OF THE INVENTION

The invention relates generally to a method for signing data.

Furthermore, the invention also pertains to a device for signing data.

The device may be a (user) terminal, an embedded chip or a smart card, as a Secure Element (or SE).

The invention is notably applicable to a mobile radio-communication field wherein the device is a mobile terminal or a chip that may be embedded, such as an embedded Universal Integrated Circuit Card (or eUICC) within a host device, or removable from a host device, as a chip included within a smart card termed Subscriber Identity Module (or SIM) type card or the like, as an SE.

Within the present description, an SE is a smart object or device that includes a chip that protects, as a tamper resistant component, physically access to stored data and is intended to communicate, preferably in a secure manner, data with the outside world, like e.g. a mobile (tele)phone, as an SE host device.

Finally, the invention pertains to a first server for signing data as well.

### STATE OF THE ART

As known per se, a Subscriber Identity Module (or SIM) card, as an SE, generates a private key and a corresponding public key. The SIM card sends the SIM public key, through a mobile phone, Over The Air (or OTA), to a server. The server is thus enabled to verify whether data signed by the SIM card is or is not valid by using the received SIM card public key.

However, such a Public Key Infrastructure (or PKI)-based solution implies to deploy an additional infrastructure in the “cloud” which is complex and expensive to implement.

Thus, there is a need to provide a solution that allows offering a digital signature service without needing to deploy any additional infrastructure.

### SUMMARY OF THE INVENTION

The invention proposes a solution for satisfying the just herein above specified need by providing a method for signing data.

According to the invention, the method comprises the following steps. A device generates a first cryptogram by using a predetermined payment transaction key, a predetermined algorithm and data relating to data to be signed, as input to the algorithm. The data to be signed is different from payment transaction data. The device sends, without going through any payment transaction channel, to a first server a first message including a request for validating a signature relating to the data to be signed accompanied with the first cryptogram and the data relating to the data to be signed. The first or a second server generates a second cryptogram by using the predetermined payment transaction key, the predetermined algorithm and the data relating to the data to be signed, as input to the algorithm. The first or the second server compares the second cryptogram to the first cryptogram. If the second cryptogram does or does not match the first cryptogram, then the first or the second server does or does not validate a signature relating to the data to be signed respectively.

The principle of the invention consists in that a device uses a predefined payment transaction key that is dedicated to a payment transaction application, a predetermined algorithm and data relating to data to be signed in order to compute a corresponding signature. The device sends, besides the data relating to the data to be signed, the signature, via a non-payment transaction channel, to a server. Then, at the server side, a cryptogram is computed using the received data relating to the data to be signed, the payment transaction key and the algorithm. A (or the) server validates the signature only if the received signature and the cryptogram computed at the server side matches.

It is to be noted that the data to be signed may be of any type. For instance, the data to be signed includes binary data, data relating to a document(s), data relating to message(s) and/or any other kind of data the origin of which has to be known to its addressee.

It is noteworthy that the payment transaction application may also be of any type, like e.g. an Europay Mastercard Visa (or EMV) application or the like.

Such an invention solution leverages on an existing Cloud-Based Payment (or CBP) type infrastructure, so as to add a digital signature service.

Thus, since the invention solution re-uses the existing CBP type infrastructure, the invention solution is simpler, quicker and cheaper to implement than deploying an add-on PKI type infrastructure in the cloud and at the device and client side.

It is further to be noted that the data relating to the data to be signed may be the data to be signed or any data resulting from a predetermined algorithm, such as e.g. a hash algorithm, the data to be signed being an input to the algorithm.

The non-payment transaction channel is distinct from a payment transaction channel that is used for sending data relating to a payment transaction and that passes through a merchant access point, like e.g. a terminal or a server. The non-payment transaction channel may use notably an OTA type channel to address the cloud.

The invention method may be automatically implemented.

Thus, a user of the device that implements the invention method is not involved to sign data except if her or his approval is explicitly requested from the device.

The invention method is therefore convenient for the user.

According to a further aspect, the invention is a device for signing data.

According to the invention, the device is configured to generate a first cryptogram by using a predetermined payment transaction key, a predetermined algorithm and data relating to data to be signed, as input to the algorithm, the data to be signed being different from payment transaction data. The device is also configured to send, without going through any payment transaction channel, to a first server a first message including a request for validating a signature relating to the data to be signed accompanied with the first cryptogram and the data relating to the data to be signed.

The device may be a terminal, a user terminal, an embedded chip or a smart card, as an SE.

The SE chip may be fixed to or removable from the device.

The invention does not impose any constraint as to a kind of the SE type. As a removable SE, it may be a SIM type card, a Secure Removable Module (or SRM), a smart dongle of the USB (acronym for “Universal Serial Bus”) type, a (micro-) Secure Digital (or SD) type card or a Multi-Media type Card (or MMC) or any format card to be coupled or connected to a chip host device.

As to the chip host device, it may be constituted by any electronic device comprising data processing means, data storing means and one or several Input/Output (or I/O) communication interfaces, like e.g. a user terminal or a terminal.

According to a further aspect, the invention is a first server for signing data.

According to the invention, the first server is configured to receive, without going through any payment transaction channel, a first message including a request for validating a signature relating to data to be signed accompanied with a first cryptogram and data relating to data to be signed. The first server is configured to generate or let generate a second cryptogram by using a predetermined payment transaction key, a predetermined algorithm and the data relating to the data to be signed, as input to the algorithm. The first server is configured to compare or let compare the second cryptogram to the first cryptogram. the first server is configured to validate or not a signature relating to the data to be signed if the second cryptogram does or does not match the first cryptogram respectively.

### BRIEF DESCRIPTION OF THE DRAWINGS

Additional features and advantages of the invention will be more clearly understandable after reading a detailed description of one preferred embodiment of the invention, given as one indicative and non-limitative example, in conjunction with the following drawings:

FIG. 1 is a simplified diagram of a mobile terminal equipment comprising a phone and a chip being arranged to sign data by using a payment transaction key and a predetermined algorithm and to send a resulting signature, via OTA, to a server that verifies or lets verify whether the signature is or is not valid, according to the invention;

FIG. 2 represents a simplified scheme for generating a cryptogram by using the payment transaction key, the algorithm that are resident on the chip, and data relating to the data to be signed, according to the invention, at a client side and at a server side; and

FIG. 3 illustrates a simplified example of a flow of messages exchanged between notably a terminal user, the phone, the chip and the server(s) of FIG. 1, so that the chip calculates the cryptogram by using the scheme of FIG. 2 and sends the cryptogram, as a signature, along with the data relating to the data to be signed, in order to validate (or not) the signature at the server side.

### DETAILED DESCRIPTION

Herein under is considered an embodiment in which the invention method for signing data that is implemented notably by a chip, like e.g. an eUICC, as an SE incorporated within a mobile terminal and a chip soldered, possibly in a removable manner, on a Printed Circuit Board (or PCB) of the terminal, at a client side.

The chip may also incorporate at least part of the host terminal component(s), like e.g. a baseband processor, an application processor and/or other electronic component(s).

Alternately, instead of an eUICC, the chip may be a Trusted Execution Environment (or TEE), as a secure area of a terminal processor and a secured runtime environment.

The SE may nevertheless have different form factors.

Instead of being embedded within its host device, the chip may be carried by a medium, such as a smart card or a dongle, like e.g. a USB type dongle.

According to another embodiment (not represented), the invention method for signing data is implemented by a device, as standalone entity, at a client side. In other words, the device, like e.g. a mobile terminal, does not cooperate with any SE, so as to generate and issue a digital signature. According to such an embodiment (not represented), the device is adapted to carry out the functions that are described infra and that are carried out by the SE and the terminal.

Naturally, the herein below described embodiment is only for exemplifying purposes and is not considered to reduce the scope of the invention.

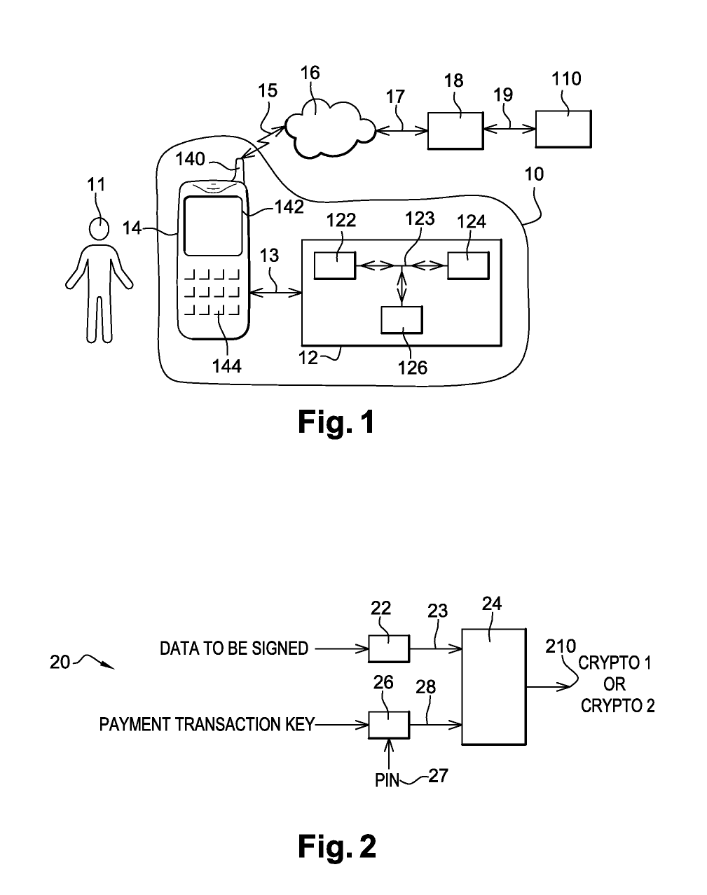

FIG. 1 shows schematically a Terminal Equipment (or TE) 10, a mobile network 16, a first remote server 18 and a second remote server 110.

The TE 10 includes a chip 12 and a mobile phone 14, as a (user) terminal and a chip host device.

For sake of simplicity, the chip 12, the mobile phone 14, the mobile network 16, the first remote server 18 and the second remote server 110 are termed infra the SE 12, the phone 14, the network 16, the first server 18 and the second server 110 respectively.

A TE user 11 benefits from a subscription to access the network 16.

The TE 10 is under a radio coverage of the network 16.

The (user) terminal, the terminal or a machine in a Machine to Machine (or M2M) context as a terminal may be either fixed (i.e. not mobile) or mobile.

The (user) terminal may be a Personal Digital Assistant (or PDA), a vehicle, a set-top box, a tablet computer, a desktop computer, a laptop computer, a video player, an audio player, a portable TeleVision (or TV), a media-player, a game console, a netbook, an electronic mobile equipment or a device accessory (like e.g. glasses, a watch or a jewel).

Instead of a phone, the user terminal or the terminal may be any other computer device including means for processing data, comprising (or being connected to) wireless communication means for exchanging data with outside, and comprising (or being connected to) means for storing data.

Within the present description, the adjective “wireless” used within the expression “wireless communication means” denotes notably that the communication means communicates via one or several Long Range (or LR) Radio-Frequency (or RF) links.

The LR RF may be fixed at several hundreds of MHz, for instance, around 850, 900, 1800, 1900 and/or 2100 MHz.

The phone 14 is preferably used for accessing one or several mobile radio-communication networks, namely at least the network 16.

The mobile radio-communication networks, as cellular communication networks, may be constituted by a Global System for Mobile Communications (or GSM), a General Packet Radio Service (or GPRS), a Universal Mobile Telecommunications System (or UMTS), an EDGE (acronym for “Enhanced Data Rates for GSM Evolution”), a Code Division Multiple Access (or CDMA) and/or a Long Term Evolution (or LTE) type network(s).

Such a cellular communication network set is not exhaustive but only for exemplifying purposes.

The phone 14 is connected, through a bi-directional link 13, to the SE 12.

The SE 12 is under control of a phone 14 (micro)processor (not represented).

The SE 12 is preferably associated with or tied to a network authentication server (not represented). The network authentication server is included within (or connected to) the network 16.

The SE 12 belongs to a user, as a subscriber to a wireless service(s).

The SE 12 includes a (micro)processor(s) 122, as data processing means, a memory(ies) 124, as data storing means, and one or several I/O interfaces 126 that are internally all connected, through an internal bidirectional data bus 123, to each other.

The I/O interface(s) 126 allow(s) communicating data from the internal SE 12 components to the chip exterior and conversely.

The memory 124 stores an Operating System (or OS).

The memory 124 stores preferably one or several SIM type applications.

The SIM type application(s) includes, among others, a SIM application for a GSM type network, a Universal Subscriber Identity Module (or USIM) application for a UMTS type network, a CDMA Subscriber Identity Module (or CSIM) application and/or an Internet protocol Multimedia Subsystem (or IMS) SIM (or ISIM) application.

The SIM type application(s) allow(s) the phone 14 to identify and authenticate to at least one mobile network 16.

The memory 124 stores, preferably in a secure manner, one or several sets of data relating, each, to a subscription, as a wireless service(s). Among the subscription data sets, there is a subscription data set relating to the network 16.

The subscription data set is identified by an IMSI, as a subscription identifier. The subscription data set relates to a Mobile Network Operator (or MNO) or a Mobile Virtual Network Operator (or MVNO), as a network 16 operator.

Each set of data relating to one subscription includes:

an IMSI, as a subscriber and a (service) subscription identifier for accessing a mobile network;

a key Ki, as a network authentication key, allowing to authenticate the subscriber to the concerned mobile network;

Milenage (or the like), as a network authentication algorithm, allowing to authenticate the subscriber to the concerned mobile network;

a file system including one or several Elementary Files (or EF);

one or several security keys, like e.g. a key(s) for ciphering/deciphering data, as secret data; and/or

one or several credentials, like e.g. a user name and/or an IDentifier (or ID) of the subscriber, as data relating to the user.

The subscription data set comprises an identifier IMSI relating to the subscription and preferably an associated key Ki, as a network authentication key, for authenticating the subscriber to the network 16.

The memory 124 may store data relating to a Uniform Resource Identifier (or URI), a Uniform Resource Locator (or URL) and/or an Internet Protocol (or IP) address of an external entity to be addressed, like e.g. a server 18 accessible within or through the network 16.

The processor 122 processes, controls and communicates internally data with all the other components incorporated within the SE 12 and, through the I/O interface(s) 126, with the chip exterior.

The processor 122 executes or runs several applications, like e.g. a payment transaction application and an invention data signing application.

Among the supported applications, the memory 124 stores the payment transaction application, like e.g. an EMV type application. The payment transaction application allows performing a payment transaction. To perform a payment transaction, the SE 12 generates a payment transaction cryptogram, like e.g. an Authorization ReQuest Cryptogram (or ARQC), by using a predetermined payment transaction key, a predetermined payment transaction algorithm, card data, like e.g. a Primary Account Number (or PAN) identifying a concerned (card) issuing bank user, and payment transaction data, like e.g. a transaction amount, data currency, that is retrieved from a Point Of Sale (or POS) terminal. The payment transaction cryptogram allows authorizing (or not) and securing the concerned payment transaction. As known per se, to authorize the payment transaction, a server, like e.g. a Token Service Provider (or TSP) in a CBP based solution, that is accessed over a payment transaction channel, verifies that the payment transaction cryptogram that is issued from the SE 12 is valid. The payment transaction channel may pass through a merchant terminal and/or a server, a (payment transaction) acquirer (bank) infrastructure and a (payment transaction) issuer (bank) infrastructure.

The memory 124 stores the payment transaction key and possibly other payment transaction keys. The (or each) payment transaction key may be restricted in use, like e.g. in time or a certain count of use, or permanent. The payment transaction key may be a so-termed limited use key or single use key. The (or each) payment transaction key may be encrypted with a Personal Identity Number (or PIN) or other user authentication data, like e.g. a fingerprint(s), an iris print(s) and/or a voice print(s), to be entered or submitted by the SE 12 user. The user authentication data to be used as a reference user authentication data is only stored at a server side (and not at the SE/phone side).

The memory 124 stores the predetermined payment transaction algorithm, like e.g. a 3 Data Encryption Standard (or DES).

The memory 124 stores the invention data signing application. The data signing application allows signing data to be signed, like e.g. a contract or any other data different from payment transaction data, as data relating to a non-payment transaction. The data to be signed may originate from any source, like e.g. the phone user, the phone 14, an external server, another terminal that is connected to the SE 12 and/or the phone 14.

To perform such a (digital) signature, as further described in relation with the FIG. 2, the SE 12 generates a cryptogram, as a non-payment transaction signature, by using a predetermined payment transaction key, the predetermined payment transaction algorithm, like e.g. the 3 DES, and data relating to the data to be signed.

Such a non-payment transaction cryptogram allows verifying that the considered signature that is issued from the SE 12 is valid.

The data signing application is preferably able to request from the SE user an approval or a disapproval for signing data to be signed accompanied with the data to be signed. To perform such a user request, the user may enter or submit a PIN and/or other user authentication data, like e.g. biometric data, such as a fingerprint(s), an iris print(s) and/or a voice print(s). The user authentication data allows preferably generating a non-payment transaction signature. For instance, to generate a non-payment transaction signature, the SE 12 uses the user authentication data to decipher a ciphered payment transaction key.

Corresponding reference user authentication data is preferably stored only at the server side. An appropriate server, like e.g. the second server 110, uses the reference user authentication data, so as to generate a non-payment transaction cryptogram. For instance, to generate a non-payment transaction cryptogram, the concerned server uses the user authentication data to decipher a ciphered payment transaction key (accessible from the concerned server). The non-payment transaction cryptogram is to be compared to a non-payment transaction signature to be received from a client device, so as to know whether the non-payment transaction signature is or is not valid.

The processor 122 is preferably able to initiate an action(s), in order to interact directly with the outside world, in an independent manner of the phone 14. Such a capacity of interaction at the initiative of the SE 12 is also known as being a proactive capacity in which the SE 12 plays a role of a master while the SE host device plays a role of a slave. According to one preferred embodiment, the SE 12 is able to use SIM ToolKit (or STK) type commands, as proactive commands.

The SE 12 is thus able to send, at its own initiative, either through (to any device, like e.g. the server 16 connected to the phone 14) or to the phone 14, a message by using a proactive command, like e.g. a “SEND SHORT MESSAGE”. Such a proactive command allows sending, through the phone 14, to the first server 18 a message including a request for validating a (digital) signature relating to the data to be signed accompanied with the (non-payment transaction) cryptogram and the data relating to the data to be signed through a mobile network connection that is(are) provided by the SE host device. Such a Short Message Service (or SMS) type message (or the like) that conveys the signature (to be verified) does not pass through any payment transaction channel.

The processor 122 executes, in a preferred manner, one or several security functions.

The security functions include preferably a local (off-line) user authentication process to be used prior to continuing to access the SE 12, notably at a boot, i.e. a power on, of the SE 12. To authenticate the user, the user has to provide a PIN or biometric data, as reference user authentication data, that is stored, preferably in a secure manner, within the memory 124. As biometric data, it may include one or several fingerprints, one or several iris prints and/or one or several voiceprints relating to one or several authorized users.

The security functions include preferably a data ciphering/deciphering function that allows ciphering/deciphering data prior to its sending/after its receiving respectively, so as to secure a data transmission with an SE interlocutor, like e.g. the first server 18.

The SE 12 is fixedly coupled or connected to the phone 14, as an SE host device.

Alternately, the phone 14 comprises the SE 12 that is removable from the phone 14.

The phone I/O interfaces include one or several I/O interfaces for exchanging data with the SE 12.

The phone I/O interface with the SE 12 may be an International Organization for Standardization (or ISO) 7816 interface, as a contact interface, when the SE 12 is inserted, in a removable manner, within the phone 14.

Alternately, instead of a contact interface, the phone I/O interface with the SE 12 is connected to or includes a contact-less interface. The phone 14 is connected to or includes means for communicating data while using preferably a Short Range (or SR) RF link. The SR RF link may be related to any technology that allows the phone 14 to exchange data, through a so-termed contact-less link with the SE 12. The SR RF may be fixed at 13.56 MHz and related to a Near Field Communication (or NFC) type technology, as a contact-less technology.

The phone 14 includes data processing means, such as one (micro)processor (not represented), data storing means (not represented), as a phone memory, and one or several I/O interfaces that are linked all together through a control and data bus (not represented).

The phone 14 plays, in a preferential manner, a role of a modulator-demodulator (or modem), so as to exchange data in a wireless manner.

The phone 14 carries out the following operations:

a modulation of an analogical carrier signal to encode digital information to be transmitted, over an antenna 140, to one (or several) network(s) 16, and

a demodulation of a received analogical carrier signal to decode the encoded digital information that is received, over the antenna 140, from one (or several) network(s) 16.

The phone memory may comprise one or several memories including one or several volatile memories and one or several non-volatile memories.

The phone memory may be constituted by one or several EEPROMs (acronym for “Electrically Erasable Programmable Read-Only Memory”), one or several ROMs (acronym for “Read Only Memory”), one or several Flash memories, and/or any other memories of different types, like one or several RAMs (acronym for “Random Access Memory”).

The phone memory stores e.g an International Mobile Equipment Identity (or IMEI), as a phone 14 identifier, and/or an email address, as an identifier(s) relating to the phone 14.

The phone memory may store, at least in a temporary manner, a configuration parameter(s) to be used for addressing the first server 18. Such a configuration parameter(s) may be provided by the SE 12. The configuration parameter(s) allow(s) configuring an access, through a connected mobile network(s) 16, to the first server 18 (comprised in the cloud).

The phone memory stores an OS and one or several applications.

The phone 14 includes preferably a display screen 142 and a keyboard 144, as Man Machine Interface (or MMI).

Alternatively, instead of a physical keyboard separated from the display screen, the phone 14 is equipped with a touch sensitive display screen, as virtual keyboard.

The phone MMI allows preferably presenting data to be signed to the phone user 11.

The phone MMI allows the phone user 11 to interact with the phone 14. The SE 12 may thus get a user approval or disapproval for signing the data to be signed.

The phone 14 is connected, over a wireless link 15, to the mobile network 16.

The network 16 is connected, over a wire or wireless link 17, to the first server 18.

The first server 18 is hosted by a computer with data processing means and data storing means.

The first server 18 may be connected, over a wire or wireless link 19, to the second server 110.

Instead of exchanging with the second server 110, the first server 18 may carry out each function carried out by the second server 110 that is described infra.

The first server 18 accesses a database stored in a memory (not represented) that is present within or connected to the first server 18.

The database may include a first correspondence table. The first correspondence table includes, for at least one identifier, like e.g. a PAN, an IMSI, an IMEI and/or a Mobile Station International Subscriber Directory Number (or MSISDN), an identifier(s), such as e.g. a URI and/or a URL, relating to a second server 110 to be addressed.

The first server 18 may be able to send to a client (device), like e.g. the SE 12, (or its user) a document and/or any other data to be signed.

The database may include a second correspondence table. The second correspondence table includes, for at least one identifier relating to data to be signed, the data to be signed. The first server 18 may thus be able to send to a client (device), like e.g. the SE 12, (or its user) a document, as data to be signed, and an identifier(s) relating to the data to be signed, as a reference to the data to be signed. If the first server 18 receives from the client device (or another device) a message including the reference to the data to be signed, then the first server 18 gets or retrieves, by using the second correspondence table, corresponding data to be signed.

The first server 18 is thus able to request the client to sign joined data (to be signed).

The first server 18 is able to receive, without passing through any payment transaction channel, i.e. through the network 16, from a client device a message including a request for validating a signature relating to data (to be signed) accompanied with a cryptogram and data relating to the data to be signed. The signature validation request message may include the reference to the data to be signed.

The first server 18 may verify whether the data relating to the data to be signed is or is not valid, i.e. received data has a predetermined length value or any other predetermined data format, and authorize continuing a data processing only if the data relating to the data to be signed is valid.

Alternately or additionally, the first server 18 may verify whether the data to be signed is or is not valid by using preferably a reference to the data to be signed to be sent to and received from a client device, i.e. e.g. a signature validation request message has been received before an expiring date and/or time, and authorize continuing a data processing only if the data to be signed is valid.

The second server 110, like e.g. a TSP, that manages a bank account relating to the phone user 11, as a (bank) issuer, is hosted by a computer with data processing means and data storing means.

The second server 110 may generate a cryptogram to be matched by a signature to be received from the server 18.

The second server 110 may be used for generating a cryptogram by using the predetermined payment transaction key, the predetermined algorithm and data relating to the data to be signed and to be received through the first server 18, when applicable. The second server 110, as cryptogram generation server, share with each client device, among which there is the SE 12, notably the payment transaction key and the algorithm to be used for generating a payment transaction cryptogram. To generate the cryptogram, the second server 110 uses preferably a reference PIN and/or reference user authentication data, like e.g. biometric data, to decipher a previously ciphered payment transaction key by the second server 110 or another server.

The second server 110 may be used for comparing the cryptogram (that is generated by itself or another server) to a signature that is issued from the concerned client device, like e.g. the SE 12.

A result of such a comparison between the generated cryptogram and a received signature is either successful, i.e. the cryptogram matches the signature, or unsuccessful, i.e. the cryptogram is distinct from the signature.

FIG. 2 is an exemplary embodiment of a way 20 to generate a non-payment transaction cryptogram, as a digital signature, both at the client side and at the server side.

Optionally, data 21 to be signed may be an input to a first algorithm 22, like e.g. a hash type function allowing to reduce a length value of the data to be signed, like e.g. a length value of the resulting data hash value is 32 digits, as data relating to the data to be signed.

The hash type function may be e.g. a SHA-256 or a MD 5 type function or the like.

A hash relating to the data to be signed, as the result or output 23 of the first algorithm, or the data to be signed itself, as data relating to the data to be signed is an input 23 to a payment transaction algorithm and a non-payment transaction algorithm, as a second algorithm 24 and a signature algorithm.

Alternately or additionally, the data relating to the data to be signed fills in one or several data fields, like e.g. card data and/or terminal data, which are used by the payment transaction algorithm 24, like e.g. a 3 DES, as non-payment transaction algorithm and data signature algorithm 24. The card data may include a PAN, an expiry date, a CVV, a transaction counter and/or other data.

A payment transaction key 25 is preferably an input to a third algorithm 26, like e.g. a XOR type function, as a ciphering function by using a (user) PIN 27 and/or other user authentication data.

A session key, as the result or output 28 of the third algorithm 26, is an input 28 to the second algorithm 24.

A result or output 210 of the second algorithm 24 is a non-payment transaction cryptogram, as a data signature.

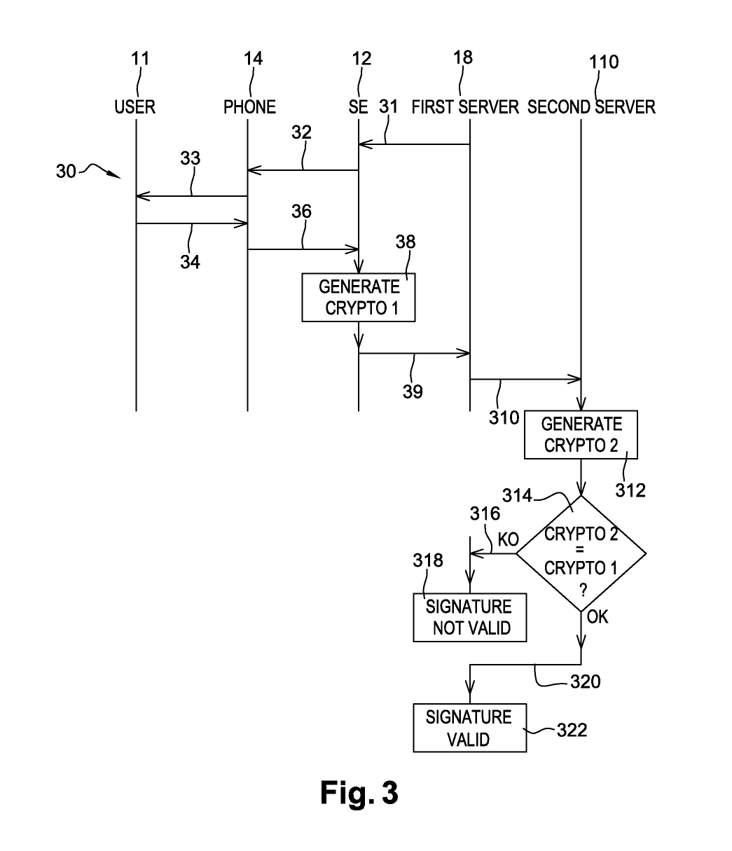

FIG. 3 depicts an exemplary embodiment of a message flow 30 that involves the SE 12, the phone 14, the first server 18 and the second server 110.

In the explained example, it is assumed that the client device is the SE 12.

It is further assumed that, besides possible data validation, the first server 18 relays information between the client device and the second server 110 that is dedicated to a cryptogram generation and comparison.

It is assumed that the phone 14 is currently under a coverage of the network 16 and a data signature process is triggered by the first server 18.

However, the invention is still applicable if the data signature process is triggered by the phone user 11, the SE 12 or any other device connected to the SE 12.

The first server 18 sends to the SE 12, as client device, a message 31 including a request for signing a document, as data to be signed, the document and preferably an identifier relating to the document.

Optionally, the SE 12 sends to the phone 14 a message 32, such as e.g. a proactive command “Display TEXT” along with the document to be displayed to the user 11 and preferably a message for requesting a phone user approval or disapproval, such as “do you approve to sign the displayed document?”, for signing the document. The phone 14 then sends to the display screen 142 (or another connected display screen) a message 33 including the document (to be signed) and the user approval request message. The phone user 11 gives (or not) her/his approval for signing the document by using the phone MMI, like e.g. by depressing a button(s) “Yes” or “No”. To give her/his approval, the user 11 may enter, through the phone MMI or the like, a PIN, as user authentication data. The user 11 sends, via the phone MMI, to the phone 14 a message 34 including a user approval request response. The phone 14 then sends to the SE 12 a message 36 including the user approval request response.

The SE 12 analyses and interprets the received message 36 and, if the user 11 gives her/his approval possibly by entering user authentication data, then the SE 12 generates 38 a first cryptogram by using a predetermined payment transaction key, a predetermined algorithm 24 (as explained in relation with FIG. 2) and a hash value relating to the document, as data relating to the data to be signed. Otherwise, i.e. if the user 11 does not give her/his approval, the SE 12 does not authorize generating 38 any cryptogram and the data signature process is terminated. Alternately, instead of a document hash value, the document data (itself) is used for generating the first cryptogram.

Then, the SE 12 sends, without going through any payment transaction channel, i.e. directly through the network 16, to the first server 18 a message 39 including a request for validating a signature relating to the document accompanied with the first cryptogram, the hash value relating to the document or the document (itself), as the data relating to the data to be signed, and possibly the document identifier (when received from the first server 18 or another entity).

The last message 39 may further include card data that is also used for generating the first cryptogram.

The first server 18 then sends, after a possible successful verification(s) of the document validity and/or a document hash value validity (not represented) by getting the document based on the document identifier, to the second server 110 a message 310 including a request for authorizing a payment transaction accompanied with the first cryptogram and the data relating to the data to be signed. The data relating to the data to be signed, i.e. the hash value relating to the document or the document data, may be included within one or several data fields that are used for transmitting data relating to card data and/or data relating to terminal data in a corresponding payment transaction authorization request message.

As soon as the second server 110 has received the last message 310, the second server 110 generates 312 a second cryptogram by using a predetermined payment transaction key, a predetermined algorithm 24 (as explained in relation with FIG. 2) and the data relating to the data to be signed, namely the hash value relating to the document or the document data.

Once the second cryptogram is generated, the second server 110 compares 314 the second cryptogram to the first cryptogram, as a payment transaction signature.

If the second cryptogram does not match the first cryptogram, then the second server 110 sends to the first server 18 a message 316 including a payment transaction refusal, as request 310 response. The first server 18 analyses and interprets the last message 316. The first server 18 does not validate 318 a resulting digital (and non-payment transaction) signature.

Otherwise, i.e. if the second cryptogram matches the first cryptogram, the second server 110 sends to the first server 18 a message 320 including a payment transaction authorization, as request 310 response. The first server 18 analyses and interprets the last message 320. The first server 18 validates 322 a resulting digital (and non-payment transaction) signature.

The digital signature is thus validated (or not) by using one and the same payment transaction key and one and the same payment transaction algorithm at the client and server sides.

The invention solution is compatible notably with the existing CBP type infrastructure when the payment transaction application is not stored within an SE and is stored within a terminal, like e.g. a tablet or a mobile terminal, as a standalone device and a non-trusted environment.

Such an invention data signature method allows re-using an existing CBP type infrastructure reducing thus a technical complexity and corresponding costs to offer a data signature service.

The invention solution does not need to involve a phone user, except for submitting user authentication data, when applicable.

The embodiment that has just been described is not intended to limit the scope of the concerned invention. Other embodiments may be given. As another embodiment example, instead of two servers 18 and 110 that are involved, only one server allows validating (or not) a signature issued by a client device.

1. A method for signing data,
wherein the method comprises the following steps:
a device generates a first cryptogram by using a predetermined payment transaction key, a predetermined algorithm and data relating to data to be signed, as input to the algorithm, the data to be signed being different from payment transaction data;
the device sends, without going through any payment transaction channel, to a first server a first message including a request for validating a signature relating to the data to be signed accompanied with the first cryptogram and the data relating to the data to be signed;
the first or a second server generates a second cryptogram by using the predetermined payment transaction key, the predetermined algorithm and the data relating to the data to be signed, as input to the algorithm;
the first or the second server compares the second cryptogram to the first cryptogram; if the second cryptogram does or does not match the first cryptogram, then the first or the second server does or does not validate a signature relating to the data to be signed respectively.

2. Method according to claim 1, wherein, prior to generating a first cryptogram, the device requests from a device user an approval or a disapproval for signing data to be signed accompanied with the data to be signed and, only if the device user approves a signature of the data to be signed, the device generates the first cryptogram.

3. Method according to claim 1, wherein, prior to generating a first cryptogram, the device requests from a device user an approval or a disapproval for signing data to be signed accompanied with the data to be signed and the device user approves a signature of the data to be signed by entering user authentication data, the user authentication data being used to generate the first cryptogram, reference user authentication data being used to generate the second cryptogram.

4. Method according to claim 3, wherein the user authentication data is used to decipher a ciphered payment transaction key at the device side and the reference authentication data is used to decipher a ciphered payment transaction key at the server side.

5. Method according to claim 1, wherein the data relating to the data to be signed includes a hash relating to the data to be signed or the data to be signed.

6. Method according to claim 1, wherein the data relating to the data to be signed is included within at least one data field that is used for transmitting at least one element of the following group:
data relating to card data;
data relating to terminal data.

7. Method according to claim 1, wherein, prior to generating a second cryptogram, the method further includes:
the first server verifies whether the data to be signed is or is not valid, the first server authorizes continuing a data processing only if the data to be signed is valid; and/or
the first server verifies whether the data relating to the data to be signed is or is not valid, the first server authorizes continuing a data processing only if the data relating to the data to be signed is valid.

8. Method according to claim 1, wherein, prior to generating a first cryptogram, the first server or another entity sends to the device at least the data to be signed.

9. A device for signing data,
wherein the device is configured:
to generate a first cryptogram by using a predetermined payment transaction key, a predetermined algorithm and data relating to data to be signed, as input to the algorithm, the data to be signed being different from payment transaction data;
to send, without going through any payment transaction channel, to a first server a first message including a request for validating a signature relating to the data to be signed accompanied with the first cryptogram and the data relating to the data to be signed.

10. A first server for signing data,
wherein the first server is configured:
to receive, without going through any payment transaction channel, a first message including a request for validating a signature relating to data to be signed accompanied with a first cryptogram and data relating to data to be signed;
to generate or let generate a second cryptogram by using a predetermined payment transaction key, a predetermined algorithm and the data relating to the data to be signed, as input to the algorithm;
to compare or let compare the second cryptogram to the first cryptogram;
to validate or not a signature relating to the data to be signed if the second cryptogram does or does not match the first cryptogram respectively.
